(19) United States
(12) Patent Application Publication
(10) Pub. No.: US 2002/0069167 A1
(43) Pub. Date: Jun. 6, 2002

(54) System and method for efficient presentment and payment of bills from multiple independent entities in a hierarchically structured business project

(76) Inventor: James Conlow, Oakland, CA (US)

Correspondence Address: LAW OFFICES OF BRIAN BEVERLY, ONE KAISER PLAZA, SUITE 2360, OAKLAND, CA, 94612

(21) Appl. No.: 10/007,266

(22) Filed: Dec. 3, 2001

Related U.S. Application Data
(60) Provisional application No. 60/250,814, filed on Dec. 1, 2000.

(51) Int. Cl. G06F 17/60

(52) U.S. Cl. 705/40; 705/34

(57) ABSTRACT

A system and method for direct presentment and clearance of bills generated in a hierarchal business organization over a network of computers comprises a hierarchal business organization having a plurality of tiers of entities related by common business interests, the tiers including billing entities, each billing entity in contractual relation with a hiring entity in a superior tier of the organization, the hierarchal business organization including at least one paying entity, the system providing for direct billing by each billing entity to a central business process administrator, direct payment to each entity by the business process administrator, and for associated inspection of the entity's work and clearance of mechanic's liens.

This application claims the benefit of U.S. Provisional Application 60/250,814, filed Dec. 1, 2000.

### BACKGROUND—FIELD OF THE INVENTION

The present invention is directed to computer-implemented bill aggregation, presentment and payment methods and systems as they are applied to a hierarchical structured business system in which multiple independent entities participate at a plurality of levels to provide a plurality of products and services contributing to completion of a project, as is common in the construction industry.

### BACKGROUND—DESCRIPTION OF THE PRIOR ART AND OBJECTS AND ADVANTAGES OF THE INVENTION

This invention arose out of the concerns associated with the high cost of the current billing and payment system in the construction industry. The current payment system is an indirect sequential system which depends on a series of interactions that contribute to delayed payments and result in high costs for professional developers, institutions, governments and homeowner consumers.

This invention benefits those entities that occupy each position in a hierarchical structured business system. Most organizations assembled to complete construction projects are structured with business entities occupying various levels (1 through N) on a multi-leveled hierarchy (see e.g. FIG. 1). These multiple independent entities provide a plurality of independent and different tasks and services to other entities above or below them in hierarchical level. The hierarchy exists to efficiently manage the complexity of organizing these entities to complete the project.

In this specification, the term Hierarchical Structured Business System or just Hierarchy is defined as any project management structure in which multiple independent entities exist at a plurality of hierarchical levels to facilitate the completion of a project. In this specification the hierarchical levels are numbered, the use of “N” in place of a number signifies the lowest numbered tier level in a given hierarchy.

FIG. 1 illustrates an N=six leveled project hierarchy simplified in that it does not show every entity that could occupy each level in the hierarchy. A top down view of this figure shows a Project Owner/Developer (First Tier Entity) contracting with a General Contractor (Second Tier Entity) to complete construction work. Any contractor that has a contract directly to the owner/developer may also be called a prime contractor. Financial institutions may also occupy a first tier position. Various design professionals, such as architects, engineers, and consultants, may also occupy a second tier position. The General Contractor in turn contracts with Third Tier Entities such as subcontractors and material suppliers and equipment vendors to complete portions of the construction work. A General Contractor (Second Tier) may contract with 30 or more individual entities at the Third Tier level for a single project. The Third Tier entities in turn contract with Fourth Tier entities such as sub-subcontractors, material suppliers, and equipment vendors to complete portions of the construction work. This contracting process of assigning portions of the work goes on until all portions are assigned to entities in the lowest tier, which is level 6 in this example.

Entities occupying tier level one may be referred as paying entities. Entities occupying tier levels two through N may be referred to as billing entities, or alternatively as vendors or vendor entities.

A real world model of the multi-level hierarchical relationships that could occur on a construction project follows:

An Owner/Developer (First Tier Entity) enters into the process of improving real estate by effecting the construction of a building. The Owner/Developer may contract with a financial institution (also a First Tier Entity) to provide funds for the process. The owner/developer contracts directly or indirectly with a design team (architects, engineers, soils specialists, and others) to design the project (the design team entities may occupy the second or lower tiers). The Owner/Developer contracts with a General Contractor (Second Tier Entity) or other prime contractor(s) to provide services for the project. For purposes of this specification, general contractors and/or prime contractors that are contracted directly to the owner/developer will be referred to as general contractor.

The General Contractor (Second Tier Entity) contracts with a set of subcontractors (Third Tier Entities) who specialize in various portions of the contemplated work. As an example of a set of included specialties: surveyors, land graders and earth movers, paving, site utilities (sewer system, storm drainage system, domestic water system, irrigation water system, fire water system), site concrete work, offsite concrete work, landscaping, irrigation, pile fabrication, pile driving, foundation concrete work, concrete reinforcing steel, structural steel work, miscellaneous steel, decorative metals, metal decking, masonry work, architectural sheet metal, roofing, insulation, floor coverings, caulking, soffits, rain water leaders, rough carpentry, finish carpentry, light gauge metal framing, doors frames and hardware, drywall installation, drywall finish, exterior painting, interior painting, t-bar ceilings, building skin specialist, architectural aluminum and glazing, elevators, fire sprinkler system, plumbing and process piping, HVAC (heating ventilating and air conditioning), electrical work, data and telephone wiring.

The General Contractor may purchase building materials from a variety of suppliers (Third Tier Entities) such as lumber, concrete, nails, bolts, steel fasteners, and others.

The General Contractor may purchase equipment such as loading dock levelers or elevators.

The General Contractor may rent equipment and tools used during the construction process such as generators, cranes and forklifts.

Each Subcontractor (Third Tier Entity) must contract with other specialists, materials suppliers, equipment suppliers and rental yards (Fourth Tier Entities). For example, the HVAC contractor (Third Tier Entity) contracts with a controls contractor, a duct shop, a process piping contractor, a detailer, and buys building materials from various suppliers, purchases air conditioning units and fans from equipment suppliers (Fourth Tier Entities).

These sub-subcontractors (Fourth Tier Entities) contract with other specialists, materials suppliers, equipment suppliers and rental yards. An example: The controls contractor (Fourth Tier Entity) contracts with an electrical contractor (Fifth Tier Entity) to run conduits and control wiring and purchases equipment and materials from various vendors (Fifth Tier Entities).

These sub-sub-subcontractors (Fifth Tier Entities) contract with other specialists, materials suppliers, equipment suppliers and rental yards (Sixth Tier Entities). An example: The electrical contractor (Fifth Tier Entity) contracts to purchase materials and equipment from various vendors (Sixth Tier Entities).

A person familiar with the art would understand that other hierarchies could exist to complete construction work and that every construction project in fact has its own unique hierarchy to satisfy its needs. This invention addresses all such hierarchies.

The hierarchical model of FIG. 1 has evolved over hundreds of years to manage the complex combinations of specialized services required to construct a project. Within this model traditional business rules regarding hierarchies are not violated, and the rules regarding chain-of-command adhered to as sacred. As will be described, traditional bill presentment and payment thereof follows the rule of never bypassing the hierarchical chain of command. Thus, in the traditional system, only entities directly contracted to the owner/developer such as prime contractors and general contractors may present bills to the owner/developer or be paid by the owner/developer. The invention preserves the management relationship, but improves on the billing and payment procedures.

As work progresses on a project, the entities described above periodically bill for portions of work. A project may last several months or years, and the entities may bill at the end of each month, at the end of each quarter, or on any other fixed or variable time basis upon which they have agreed. If an entity has partially completed a portion of work when a bill is presented, that entity will bill only for the partially completed portion. This traditional billing process is described in the following paragraphs.

According to the traditional method of bill presentment in a hierarchical business structure (FIG. 2), lowest tiered vendor entities bill the next higher-level entities for work. At each tier level, a sorting and aggregation process takes place by each entity in that tier to accrue bills from lower tiers and combine them with said entity's own charges (costs and fees) to create a bill that is submitted to an entity on the next higher tier. Submission of bills usually uses traditional mailing methods. Thus, in a method similar to the old bucket-brigade system of firefighting, the traditional method requires several intermediate steps in a sequential process to prepare a bill for submission to the paying entity.

The traditional billing method may use a form called a Schedule of Values (SOV) to differentiate between various items of work for which entities may bill. Each entity may break down its total work into items for this Schedule of Values. For each of the items included, the vendor may aggregate charges, including its own charges for value that it has added, together with labor, materials, and equipment charges billed to it by its lower-tiered suppliers and/or subcontractors.

The traditional method of creation of a SOV form requires a compilation of differing systems of costing (pricing) at each level to enter into the SOV. Each item or task that appears on a traditional SOV will usually be an aggregate of work and items supplied by several entities.

For example, referring to the real-world model above, an HVAC (heating, ventilating and air conditioning) subcontractor could have a task called “Controls” associated with only a single aggregated cost figure entered into the Schedule of Values. In reality, however, the controls cost would be composed of multiple subtask cost items, such as those for wiring labor, wiring materials, labor to install thermostats, thermostat equipment, labor to program the controls, software costs, etc. Many of these subtasks may have been provided by lower tiered entities. Similarly, the HVAC subcontractor could have several other tasks, such as 1) install ducts, 2) install boilers, and 3) furnish and install rooftop air conditioners. Under the method of the invention, such tasks would also be associated with only a single aggregate cost figure, rather than separating out the HVAC subcontractor's own charges from all of the charges billed to the HVAC subcontractor by its lower tiered suppliers and subcontractors.

In the traditional method of billing, tasks are not precisely defined in the same way as tasks are defined in the invention. As illustrated above, vendors traditionally define tasks broadly and aggregate work done by multiple entities in the hierarchy in calculating the charges for those tasks. Tier members themselves define tasks and are responsible for billing, payment, and waiver or release of liens/claims, and they do so via complicated steps with other tier members up and down the hierarchy. Therefore the traditional definition of tasks does not provide for sufficiently detailed information to identify and facilitate direct billing from and payment to suppliers and subcontractors (lower-tiered entities), or to process the release of associated liens and lien claims using a computerized business process administrator over a distributed network.

The traditional billing process usually also requires certain other entities to inspect and approve the completeness or progress of the portions of the work included on the submitted bills. These entities may be tier members, such as the architect and/or the financial institution, or third parties such as government official(s) or hired inspectors. Each billing period the owner/developer or general contractor must direct these different personnel to perform these inspections and approvals. These entities will be referred to hereafter as Bill Authorizing Entities.

Every vendor entity who adds value to the project has a right to be paid according to the terms of its contract. In most jurisdictions, vendors' rights to be paid are supported by the use of mechanic's liens and other legal procedures (such as a stop notice). The benefits of these claim procedures accrue to each vendor who has completed work or supplied materials or labor on a project. Lien rights exert a powerful hold on real property and construction funds and constitute a significant liability to the property owner. An unpaid lien holder may file a legal action and foreclose on the real property being improved to get paid. Thus, as the lien holder is paid for its work, its mechanic's liens and other claim rights must be waived or released in order to avoid potential liability problems for the project's owner or developer. Hereinafter these releases and waivers of mechanic's liens and other claims may be referred to as “claims release” to simplify the description.

In traditional claims release procedures (FIG.3), lowest-tier vendor entities send the next higher-level entities ‘conditional’ claims release documents as work progresses and is billed. After receiving progress payments the entities must provide ‘unconditional’ claims release documents up the hierarchy. Final lien waivers or releases are provided after final payment. This lien process proceeds up the hierarchy in sequence until it reaches the payment Entity(ies).

Traditional payment procedures (FIG. 4) flow opposite to the billing flow in FIG. 2. Thus, the paying Entity(ies) pays the highest tier vendors first, and these then pay the next lower level vendors. This payment process ideally continues until the lowest level vendors have been properly paid.

An example of the combined traditional billing, presentment of lien releases, and payment procedures as applied to a six-tiered project follows.

Billing (FIG. 2) and Releases (FIG. 3)

Every Sixth Tier Entity Bills a Fifth Tier Entity 162

This bill is created by a given Sixth Tier Entity calculating its own charges (costs and fees), preparing a paper invoice and submitting it to the Fifth Tiered Entity. In addition to the bill, a “Conditional Waiver and Release of Mechanic's lien and other Claims” is prepared by the sixth tier entity and submitted. 164

Every Fifth Tier Entity Bills a Fourth Tier Entity 152

This bill is created by sorting and organizing bills from the lower tiers and adding them together with the given Fifth Tier Entity's charges, typically preparing a paper invoice and submitting it to the Fourth Tiered Entity. In addition to the bill, a “Conditional Waiver and Release of Mechanic's lien and other Claims” is prepared by the fifth tier entity and submitted. 154

Every Fourth Tier Entity Bills a Third Tier Entity 142

This bill is created by sorting and organizing bills from the lower tiers and adding them together with the given Fourth Tier Entity's charges, preparing a paper invoice and submitting it to the Third Tiered Entity. In addition to the bill, a “Conditional Waiver and Release of Mechanic's lien and other Claims” is prepared by the fourth tier entity and submitted 144.

Every Third Tier Entity Bills a Second Tier Entity 132

This bill is created by sorting and organizing bills from the lower tiers and adding them together with the given Third Tier Entity's charges, preparing a paper invoice and submitting it to the Second Tiered Entity. In addition to the bill, a “Conditional Waiver and Release of Mechanic's lien and other Claims” is prepared by the third tier entity and submitted 134

Every Second Tier Entity Bills the First Tier Entity(ies) 122

This bill is created by sorting and organizing bills from the lower tiers and adding them together with the given Second Tier Entity's charges, preparing a paper invoice and submitting it to the First Tiered Entity(ies). In addition to the bill, a “Conditional Waiver and Release of Mechanic's lien and other Claims” is prepared by the second tier entity and submitted 124

As discussed above, First Tier entities usually require that all billed work first be approved by bill authorizing entities, prior to payment. This is accomplished by sending a copy of the bill to an authorizing entity, such as the architect, who may visit the site and check to see that the work has been performed and the materials billed for are actually in place before authorizing payment. In many instances, multiple authorizations by different entities are required. This approval process requires that experts make judgments regarding items of work that are aggregated in complicated ways (e.g., consider the difficulty of judging the partial completion of “Controls” by the HVAC subcontractor in the above example). Often multiple adjustments in the bill are required due to differing interpretations of the billing entity's job progress. Thus, the traditional method of billing results in a complicated correction procedure (down and up the hierarchy, perhaps several times) to arrive at agreed bills and conforming claims releases, and a complete report for submission to the Owner/Developer. These adjustments delay payment within the entire hierarchy, resulting in substantial periods of costly self-funding by affected entities on all levels of the hierarchy.

The payment process is shown in FIG. 4. Financial Institution(s) (First Tier) may loan money to the Owner/Developer (First Tier). The Owner/Developer checks for vendor signatures on waivers or releases of mechanic's liens and other vendor claims. When signatures are in order, and the work has been approved by the bill approving Entity(ies), the Owner/Developer pays each Second Tier Entity with which it is in contract 116; each Second Tier Entity then pays each Third Tier Entity with which it is in contract 126; each Third Tier Entity then pays each Fourth Tier Entity with which it is in contract 136; each Fourth Tier Entity then pays each Fifth Tier Entity with which it is in contract 146; and each Fifth Tier Entity then pays each Sixth Tier Entity with which it is in contract 156, until, step by step, all payments in a given period are made. These payments are usually sent using traditional mailing methods.

The payment process goes on period-by-period (usually month-by-month) with the Owner/Developer paying a portion each period of the aggregated bills, less retention, until the project is complete. At that time, the vendors will bill for retention amounts and submit conditional waiver and release of mechanic's liens and other claims release documents. The Owner/Developer pays the retention, and the vendors submit a final waiver or release of mechanic's lien and other claims documents. The Owner/Developer may use other procedures for this final payment and final claims release process to ensure receipt of the final releases.

In summary, the traditional construction billing and payment process, whether it uses primarily “paper and ink” and/or computer billing programs, has the disadvantage that it requires many sequential interactions up and down the tiers of the hierarchy with respect to the individual bills and payments, as well as processing the associated waiver or release of mechanic's liens and other claims forms. These interactions take substantial time and effort and result in mistakes and disputes. In addition, the intermediate vendor entities, who are responsible for passing payments from tier one downward, may hold money, in some cases for an extended period. Thus, lower level vendor entities are often paid several months after payment is due for completed work. The length of time between work completion and payment receipts requires that these vendors bid substantial incremental sums of money to compensate them for the cost-of-money over time. Under the traditional process, these inherent and unavoidable costs and finance charges are ultimately charged to the project owners. Thus, it is not surprising that many legal actions result from such inefficiencies.

The current indirect sequential billing method is the only method used in the construction industry. Although this method is cumbersome and slow in view of the invention described herein, the indirect billing method is firmly ingrained in the thinking of business practitioners in this industry. As previously mentioned, within the hierarchical model, business rules driving billing methods clearly forbid bypassing any of the levels in the hierarchical business structures, based on the supposition that “privates” don't communicate with “generals.” Direct dealings between the first tiered owner/developer and any entity below the second tier prime/general contractor is not “allowed” in the traditional system, each entity having specific contract obligations to bill and pay for in a well-defined manner.

The use of escrow services and trust accounts within the traditional system is cumbersome and slow due to the increased paperwork involved.

It is therefore desirable to create a construction billing and payment system that reduces complexity, increases efficiency and security, speeds up billing and payment, and reduces inaccuracies. This invention will save time and money for all purchasers of construction services, particularly homeowners.

Another area of improvement addressed by the invention is the ability to audit charges from low-level entities. It is difficult, if not impossible, under the traditional method, to audit these vendors for savings that could benefit project owners. In the traditional process, it is not uncommon that two vendors charge for the same task. Using traditional methods, this double-charge is rarely discovered.

Several processes of billing in a computerized environment have been introduced. For example, U.S. Pat. No. 5,943,656 to Crooks, et al., discloses a billing system where billing information is scrutinized according to predetermined parameters prior to presenting utility bills to paying entities. This patent does not teach direct billing in a multi-tiered hierarchical organization. Nor does this patent teach handling of claims releases associated with improving real property. Nor does this patent teach third party authorization of bill payment. U.S. Pat. No. 6,038,547 to Casto discloses a system in which a construction job is partitioned into physical regions for ease of third party review of bills from prime/general contractors. This patent also does not teach direct billing by (nor direct payment to) all the entities in the hierarchical organization. Rather, it addresses exclusively bills, specifically partitioned by physical region, from only those highest-level entities that can be paid directly by the owner/developer using the traditional method. The great majority of bills, which are generated by lower leveled subcontractors, cannot be paid directly by the owner/developer under this patent, but are paid indirectly by an entity higher up in the hierarchy of the traditional sequential method. Nor does Casto teach handling of claims releases associated with improving real property as is required to pay a bill for a construction project in most jurisdictions.

No prior art processes address the totality of needs of complex construction projects organized as a hierarchical structured business system. The present invention provides for an impartial, centralized, computer-implemented process, called a Business Process Administrator (BPA), to solve the deficiencies of the traditional system described above. The BPA performs the following functions, which are the objects of this invention:

A software process within the BPA uses novel task identification and cost breakdowns from the vendors. These breakdowns require entries not contained in traditional Schedule of Values breakdowns, such as definition of tasks in such a manner that they can be readily inspected, and identification of each vendor's value-added charges for these tasks to expedite the approval process, avoid redundant billing or double payment, and to provide for efficient claims releasing.

A software process within the BPA identifies single or multiple agents required to inspect and approve each partially or fully completed task and to provide those agents with a process for correcting bills and reporting the results of their inspections and their approvals or disapprovals to the paying entities.

An optional software process within the BPA creates waiver or release of mechanic's liens and other claims forms for signature by each vendor that has a mechanic's lien or other claim on a project and then creates a unique report for the project owner detailing these waivers or releases.

A software process within the BPA implements direct bill presentment (and optionally direct claims waiver or release presentment), and direct payment, of accurate bills for each partially or filly completed and approved task individually performed by any billing entity located in the hierarchy, without requiring intermediate action or approval by any other billing entity. This process facilitates auditing of each entity throughout the hierarchy and each task performed for a project.

### BRIEF SUMMARY OF THE INVENTION

The present invention provides a computer-implemented method and system for direct and simultaneous billing by, and direct payment to, billing entities in hierarchically structured business systems such as are used for construction projects. It also provides an option for associated direct waiver or release of mechanic's liens and other claims.

Referring to FIG. 5, the present invention includes a computer-implemented method and system that provides the ability for any entity occupying the second, third, fourth, fifth, sixth, or (nth) tier of a hierarchy to bill directly to the first tier bypassing the prior art sequential method as shown in FIG. 2 as described above.

Referring to FIG. 6, the present invention includes a computer-implemented method and system that provides the ability for any entity occupying the second, third, fourth, fifth, sixth, or (Nth) tier of a hierarchy to release mechanic's liens and other claims directly to the first tier bypassing the prior art sequential method shown in FIG. 3 as described above.

Referring to FIG. 7, the present invention includes a computer-implemented method and system that provides the ability for the Paying Entity(ies) to directly pay any entity occupying the second, third, fourth, fifth, sixth, or (Nth) tier of a hierarchy bypassing the prior art sequential method shown in FIG. 4 as described above.

Each billing entity in the hierarchy provides periodic bills (called progress bills), and, optionally, individual mechanic's lien and other claims waivers or releases (called conditional, unconditional and final claims releases), directly to the paying entity using the Business Process Administrator (BPA), rather than sending a bill to the entity directly above it in the hierarchy. The progress bills are organized and generated using a unique task identification and cost procedure. The requirements imposed by this task identification and cost procedure differ from the traditional requirements imposed on billing entities in that each billing entity must specifically identify tasks composed of only items that the billing entity itself adds to the value of the project and the charges for these “value added” items. These tasks must also be defined so that inspections of partially completed work on the tasks can easily be accomplished by authorizing entities. This unique task identification and cost association is required to expedite approvals, to avoid redundant billing, and prevent double payment for any of the tasks.

In each progress period, the BPA processes each billing entity's bills, selects authorizing entities, and presents an overall billing report containing entity bills, approvals by the authorizing entities, and optionally a claims release report showing waivers or releases signed by the billing entities, directly to the Owner/Developer and/or Financial Organization. The Owner/Developer causes approved bills to be paid directly to each billing entity, using the BPA or other means. The BPA receives notice of said payment. The process continues until the authorizing Entity(ies) certify that the entire project is complete and all billing entities are paid in full.

### BRIEF DESCRIPTION OF THE DRAWINGS

FIG. 1 is an organizational block diagram illustrating the hierarchical structure of entities contributing to a construction project.

FIG. 2 is a diagrammatic illustration of the prior art sequential bill presentment method within the hierarchical structure of FIG. 1.

FIG. 3 is a diagrammatic illustration of the prior art sequential bill lien/claims release presentment method within the hierarchical structure of FIG. 1.

FIG. 4 is a diagrammatic illustration of the prior art sequential bill payment method within the hierarchical structure of FIG. 1.

FIG. 5 is a diagrammatic illustration of a direct bill presentment method according to the invention.

FIG. 6 is a diagrammatic illustration of a direct bill lien/claims release method according to the invention.

FIG. 7 is a diagrammatic illustration of a direct bill payment method according to the invention.

FIG. 8 is a high level diagrammatic illustration of the billing and bill payment cycle according to the implementation of the invention shown by FIGS. 5 and 7 in combination.

FIG. 9 is a high level diagrammatic illustration of the billing, bill payment and lien/claims release cycle according to the implementation of the invention shown by FIGS. 5, 6 and 7 in combination.

FIG. 10 is a flow diagram of the computer-implemented method of the Business Process Administrator according to the preferred embodiment of the invention.

FIG. 11 is a flow diagram of the computer-implemented method of the Business Process Administrator according to an alternate embodiment of the invention.

FIG. 12 is a diagrammatic illustration of a computer having a memory and processor in communication with multiple entity nodes in accordance with the invention FIG. 13 is a flow diagram of a computer-implemented method of checking for duplicated tasks in accordance with the invention.

FIG. 14 is a flow diagram of a computer-implemented method of comparing a billed amount for a task against a stored amount for that task in accordance with the invention.

FIG. 15 is a flow diagram of a computer-implemented method of calculating a retention amount in accordance with the invention.

FIG. 16 is a flow diagram of a computer-implemented method of calculating a discount amount in accordance with the invention.

FIG. 17 is a flow diagram of a computer-implemented method of calculating a fee for a bill in accordance with the invention.

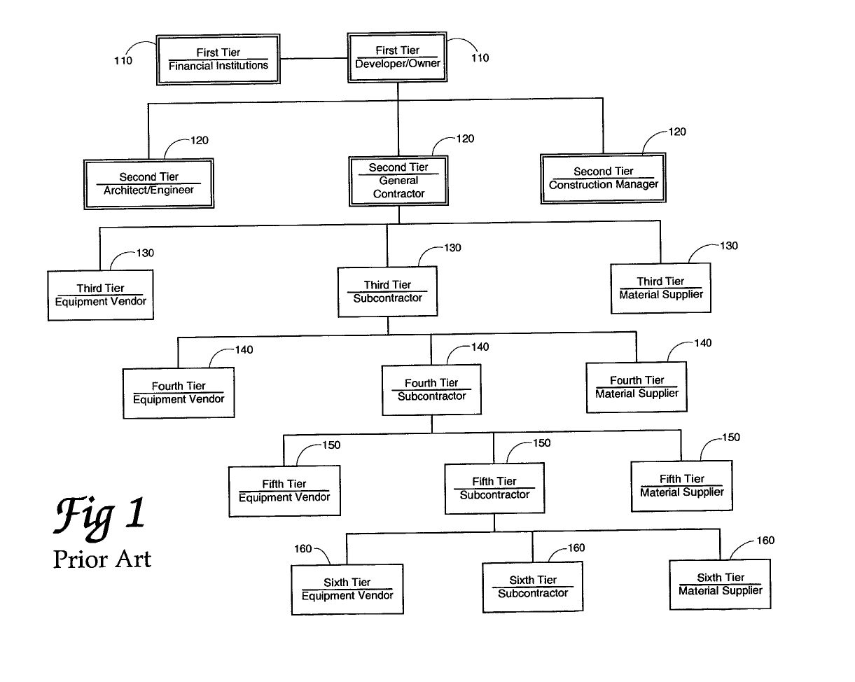

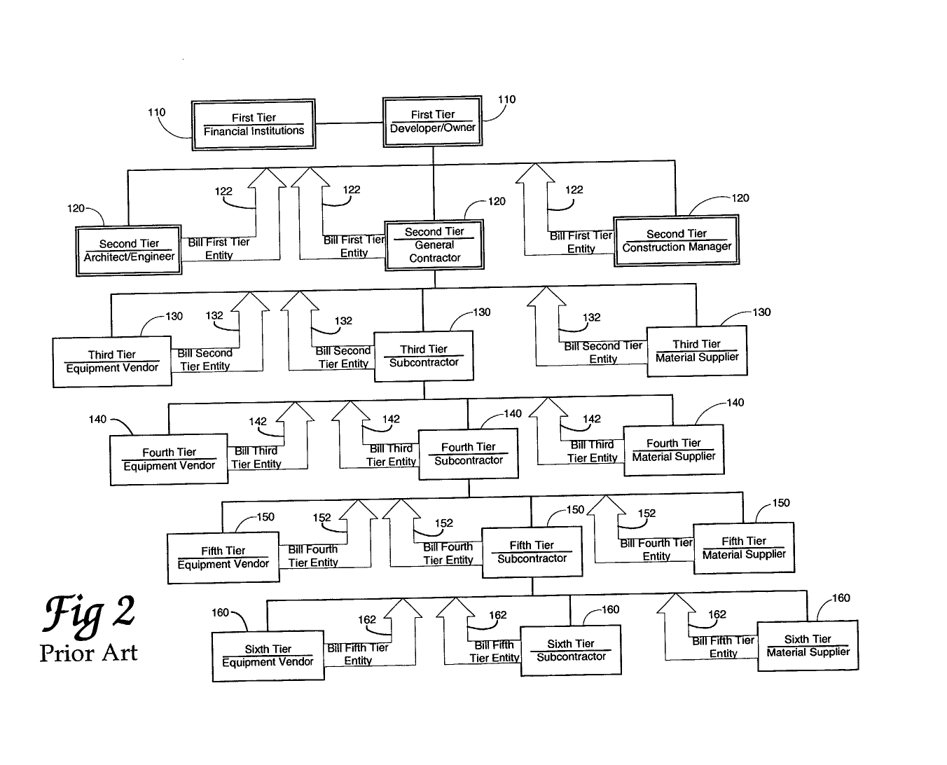

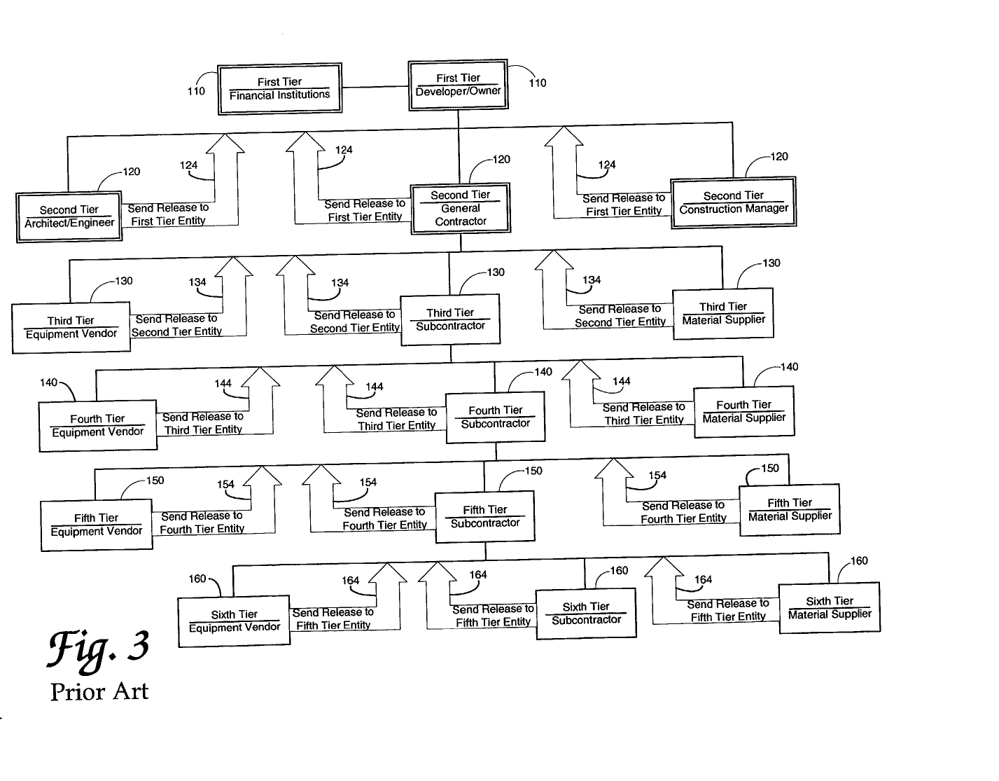

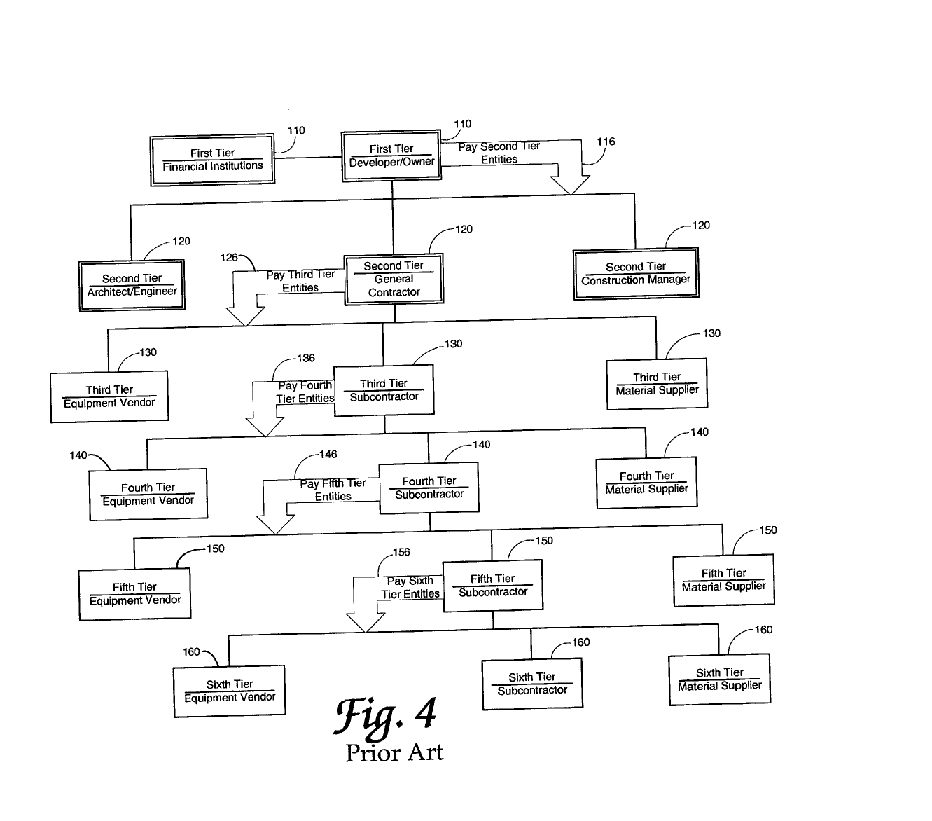

### DETAILED DESCRIPTION OF THE PREFERRED EMBODIMENTS

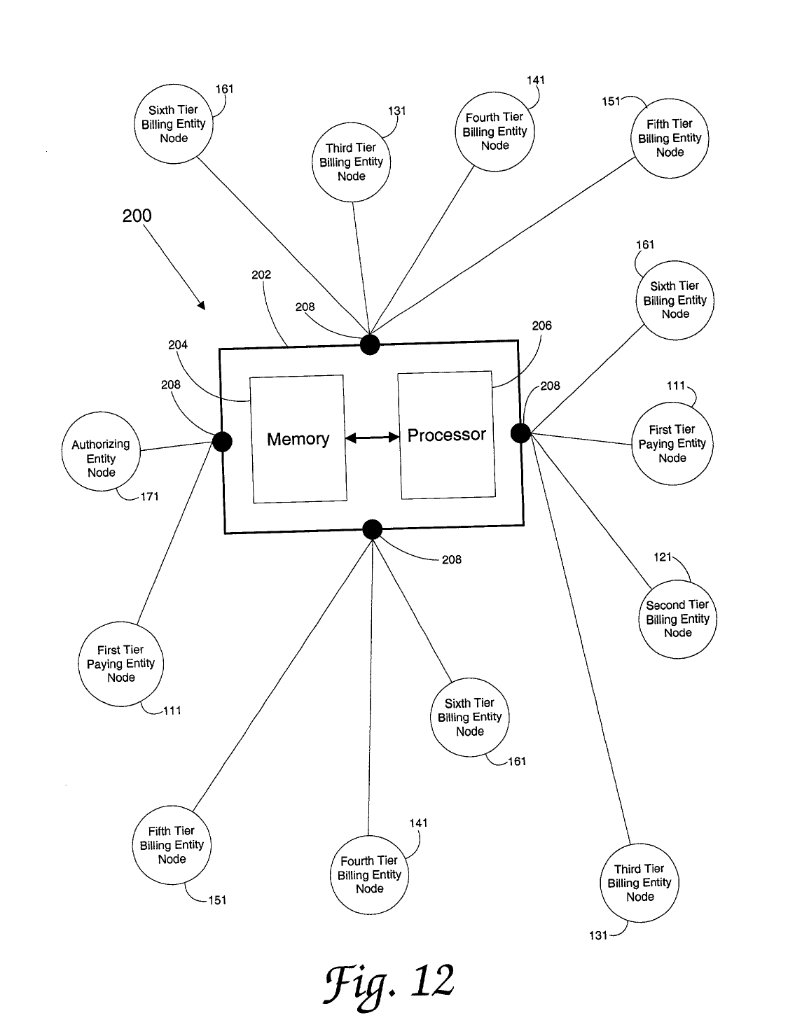

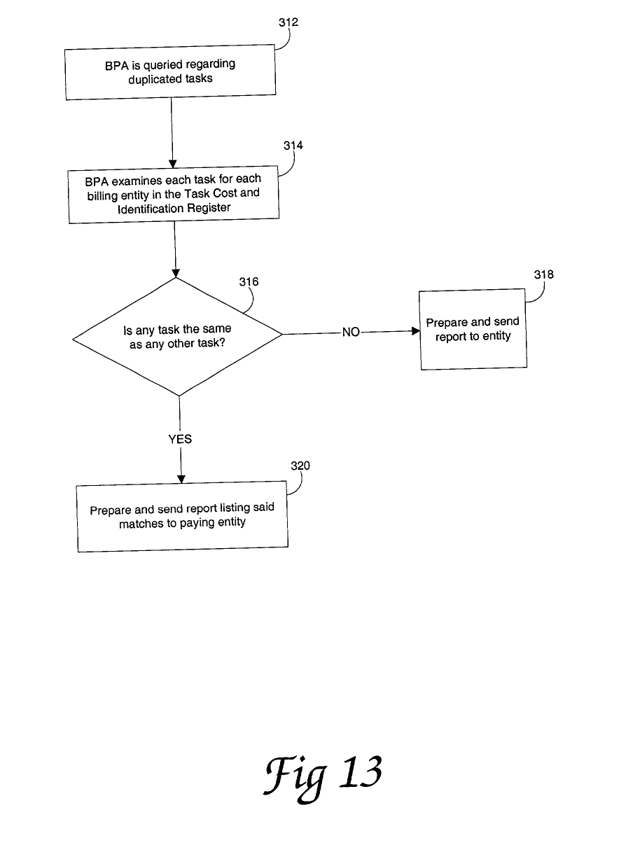

The invention 200 is a computer-implemented business process and system best shown in FIG. 12. The process is implemented by software on computers in a system called the “Business Process Administrator” or BPA 202. The BPA is implemented using computers each having at least one memory 204 and at least one processor 206. The aspects of the present invention are described in terms of steps executed or executable by software within the BPA. Preferably the invention operates on information transmitted between client entities and the BPA over network interfaces 208 on a network of computers. In the preferred embodiment, client entities include billing entities, paying entities, and authorizing entities. Each entity in the hierarchical business organization has an associated node. For example, as seen in FIG. 12, billing entities are represented by billing entity nodes 121, 131, 141, 151, and 161; a paying entity is represented by a paying entity node 111; and an authorizing entity is represented by an authorizing entity node 171. When an entity does not have a computer, or such a network between entities is unavailable, information may be provided to and from the computer-implemented BPA by other means, such as by mail, telephone, radio, or personal contact. An entity can be a natural person, corporation, partnership, a governmental body, or any other business organization or entity that makes a contribution to a common business interest. The BPA recognizes at least two primary classes of entities: Paying entities and billing entities (billing entities are sometimes referred to as vendors). Further, authorizing entities may be designated, as required, to approve work performed and the costs for that work according to entity contracts. An authorizing entity may also be a paying or billing entity, an agent of a paying or billing entity, or a third party, such as a government official.

The BPA facilitates correction of documents and/or information provided by the billing, payment and authorizing entities as required by methods known in the art. These correction loops have been left out of the following to simplify the description. In practice there will be many possible use and/or case paths. The software described in this invention will check all newly entered data with stored data for accuracy and will also check for missing data fields. If inaccurate or missing fields are discovered, the software will prompt users to correct or add the data using methods known to the art.

Mechanisms typical to software processes, such as storing and retrieving data and communications between client and server computers have been left out of the description to simplify the understanding of the business process. At every step, information is always stored or retrieved using system memory 204, as may be required, by methods known in the art. At every step, communication protocols between networked computers, e.g., computers having a client and server relationship, and computers linked over a wide area network, are used as known in the art. Interactions between entities and the BPA may use encryption, signatures (digital or by hand), authentication (a user is who he says he is), authorization (the user is authorized to be where he is on the system), nonrepudiation (the user really is the one who sent the message), privacy (no one has read or tampered with a user's message) and other validation methods as known in the art. Typical interactions between entities and the BPA may involve an entity using BPA software on a user's computer, and implementing the BPA software from a remote client computer using interactive communication interfaces, e.g., web pages. The descriptions herein do not describe how a client computer accesses a server computer, as this process is well known. Other interactions between entities and the BPA may involve direct input into the BPA without using a client computer or network. Any location from which the BPA receives a communication or to which the BPA sends a communication is a node.

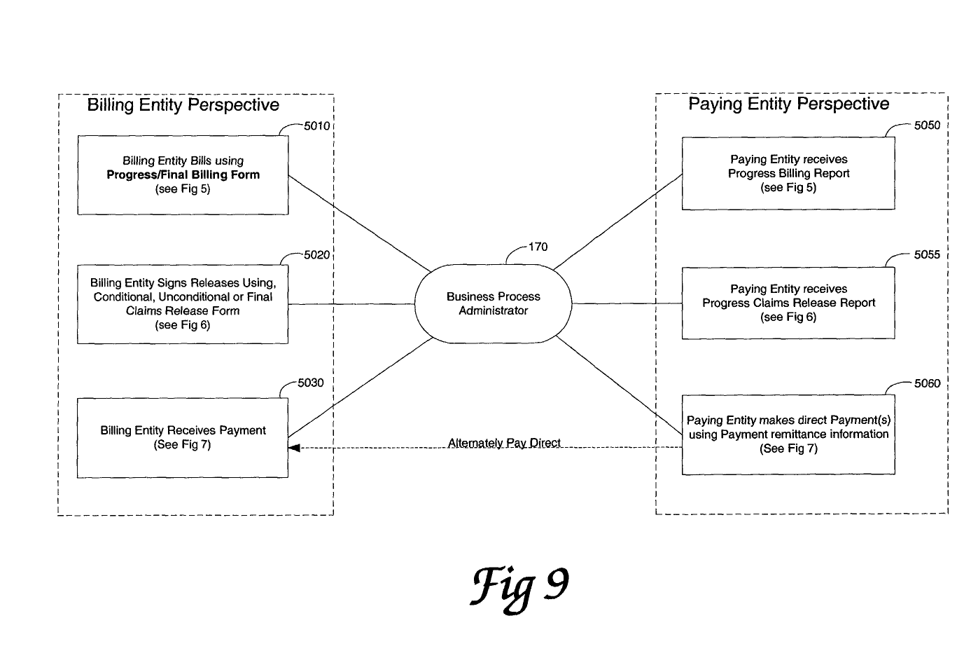

Two alternative embodiments of the invention are shown in FIGS. 8, 9, 10 and 11. The following are definitions of terms used in describing these embodiments.

Task: A task is an item of value provided by only one entity, which entity may therefore have a right to a mechanic's lien or other property claims right protecting it in the event of non-payment. A task must satisfy the following constraints: 1) the task represents value to the project (e.g., design, information, supplies, equipment, labor) added by only the associated billing entity and no other billing entity (the task may contain value added by a lower-tiered entity that chooses not to bill and be paid directly by the Paying Entity(ies), but rather to bill and be paid by the above named billing entity, provided this lower-tiered entity does not assert a mechanic's lien or other property claims right), and 2) the task is defined with sufficient clarity that both partial and full completion of the task can be inspected and verified by an authorizing entity.

Waiver and/or Release of Mechanic's Lien and other Claims: In most jurisdictions, each billing entity's right to be paid for tasks completed according to project agreements is supported by the use of mechanic's liens and/or other claims (such as stop notice). These legal tools essentially put a “hold” on project property or unexpended project funds. Mechanic's liens and other claims rights must be waived or released by each billing entity lien holder as that lien holder is paid for its work. Lien rights secure payment for the working entity and avoid liability problems for the owner or project developer. For purposes of this specification, any such release or waiver will be referred to as a “claims release.” A claims release may be conditional, unconditional, final, or any other form permitted by law. A conditional claims release is contingent on receiving partial payment. An unconditional claims release is not contingent on receiving partial payment, but is not yet final because only a partial payment has been received. A final claims release reflects receipt of full payment. The descriptions below illustrate processing of conditional, unconditional and final claims releases, although it should be recognized that the system can process other types of claims releases as may be required by any local jurisdiction.

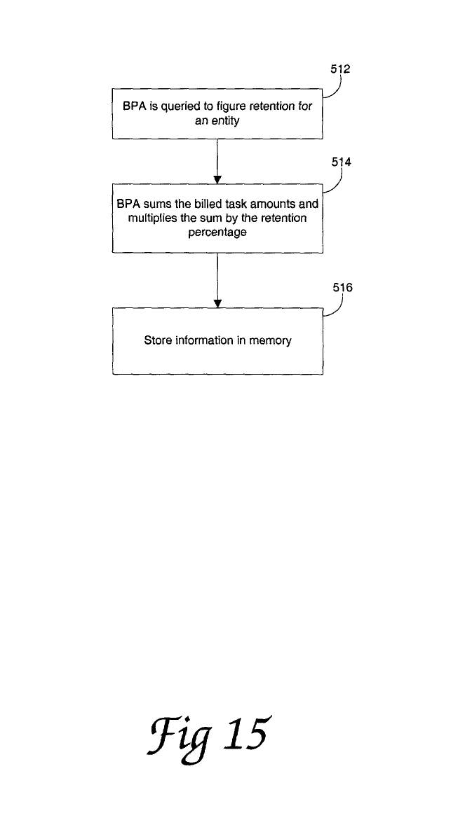

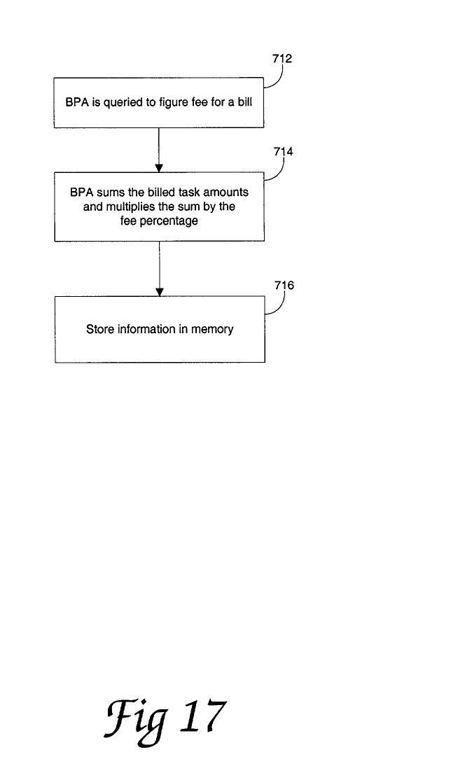

Retention: Billing entities and paying entities frequently agree that portions of monies owed to billing entities for each billing period may be withheld from the progress payments, even if work has been done properly and approved by the authorizing entities. Under a typical agreement, these “retention” amounts are paid upon completion of the project and not as an increasing incentive to performing entities to complete their work. Referring to FIG. 15, it is seen that the BPA will calculate the retention. If queried to do so for an entity 512, the BPA sums the billed tasks amounts and multiplies that sum by a retention percentage 514. The amount is stored in memory 516. As an adjunct to the retention calculation the BPA calculated a fee for a bill. As seen in FIG. 17 upon being queried to do so 712, the BPA sums the billed task amounts and multiplies that sum by a fee percentage 714. The fee is stored in memory 716.

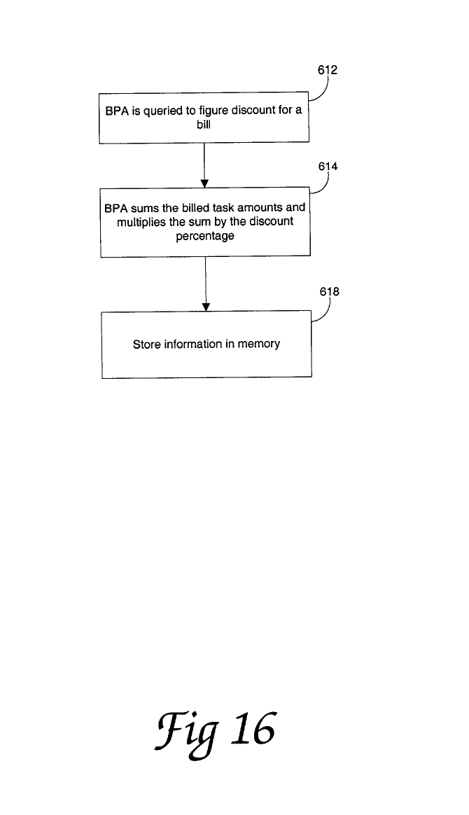

Discount: A billing entity typically submits a bill to a paying entity for payment. According to the invention the bill may be reduced by a discount amount. Thus, as shown in FIG. 16, if the BPA is queried to figure a discount for a bill 612, the BPA calculates a discount amount based on the billed total amount submitted by the billing entity 614, and stored the discount amount in memory 618. The BPA calculates a discounted bill total amount by subtracting the discount amount from the billed total amount.

Forms: The BPA creates and uses several forms which facilitate and control interactive communications between a user, such as a billing entity, authorizing entity, or paying entity, and the BPA. The BPA facilitates collection and organization of information for storage in memory by creating a variety of templates. Each template is organized into informational fields coordinated with the structure of data sets in computer memory. The templates are populated with information appropriate for the recipient and the purpose of the template. For example, progress billing forms incorporate the prior billing history of the billing entity on the project to make the job progress readily apparent. Forms are uniquely generated for each entity based on identity and historical information, such as specific tasks costs. The following are representative of the types of forms that are used. A person familiar with the art would understand that the invention could process other form styles.

Project Identification Form is the form used by each paying entity to input and transmit information important to a project to the BPA, such as: identity of owner/developer, financial institution, business types, mailing addresses, street addresses, business phone numbers, email addresses, contact persons, individual personnel levels of system access and authority, business organizational information, financial and banking information, project name, project physical location, contracts, relationships with other entities, probable project schedule, project billing specifications, passwords, security levels, authorized access by individuals, trust accounts, escrow services, and identification of authorizing entities.

Billing Entity Identification Form and Authorizing Entity Identification Form are the forms used by each billing entity or authorizing entity to input information into the BPA regarding the entity's identity and connection to the project. Such information would include: name of each entity, legal form of business, mailing addresses, street addresses, business phone numbers, email addresses, contact persons, individual personnel levels of system access and authority, business organizational information, financial and banking information, project name, project physical location, contracts, relationships with other entities, passwords, security levels, and authorized access by individuals.

Task Identification and Cost Form is the form used by each billing entity to list each of its tasks, associated total charges, and other task-related information. This form will also be used to enter mechanic's lien information and other claims information.

Progress Billing Form is the form each billing entity fills out to bill for tasks partially or fully completed during the preceding billing or “progress” period. Progress Billing Forms are submitted until each billing entity has billed for 100 percent of the money owed (including retention) per its project agreements.

Progress Authorization Form is the form created by the BPA by compiling information from the Task Identification and Cost Register (see below), the Progress Billing Forms and other project information. It shows the amounts billed and the progress of each task as stated by the billing entity during each progress period. This form may be organized to show task interdependencies. It is used by each authorizing entity to facilitate progress inspections, confirm the progress of each task, evaluate the cost of that progress, and make adjustments to billed amounts as required by the outcome of inspections. The Progress Authorization Form also may be used to enter information regarding percentage of total project completed.

Conditional Claims Release Form is a form created by the BPA through the manipulation of stored data and signed by each billing entity prior to receiving progress payments. Each billing entity promises to release liens and/or claims upon the condition of receiving the progress payment.

Unconditional Claims Release Form is the form created by the BPA through the manipulation of stored data and signed by each billing entity, following receipt of progress payments, to release claims not subject to any conditions.

Final Claims Release Form is the form created by the BPA through the manipulation of stored data and signed by each billing entity following receipt of final payment as an unconditional and final release of claims.

System Memory: The BPA collects the information provided via these forms. The information is manipulated, organized and stored in system memory in a variety of data sets comprising a plurality of record fields. The data sets include the following:

Task Identification and Cost Register: The Task Identification and Cost Register contains information for each Task (as defined above) on a project. The Task Identification And Cost Register may contain the following information in record fields for each Task:

1 Project Identification Number

Relationally gives access to project information that may be contained in the Project Identification Register

2 Billing Entity Name

3 Billing Entity Identification Number

Relationally gives access to entity information that may be contained in the Entity Identification Register

4 Task Name

5 Task Identification Number

6 Total Cost of Task

7 Amount of Total Cost Billed (Each Period)

8 Percentage Complete as Billed (Each Period)

9 Mechanic's Lien and other Claim Records

Mechanic's liens and other claims for each task are entered as records via the Task Identification and Cost Form

10 Claims Release Records (Each Period)

The released claims for each task are entered as records via the Claims Release Forms

11 Authorizing Entity(ies) Identification

12 Authorizing Entity(ies) Records (Each Period)

The authorizations of partial or full completion for each task are entered as records via the Progress Authorization Forms

13 Adjustment(s) to “Amount of Total Cost Billed” based on Progress Authorization Forms (Each Period)

14 Change Register

General audit trail for changes and adjustments.

Project Identification Register which stores the information received via the Project Identification Form such as:

1 Project name

2 Project Identification Number

3 Project physical location (address)

4 Owner/Developer identification

5 Financial institution identification

6 Business types

7 Mailing addresses

8 Street addresses

9 Business phone numbers

10 Email addresses

11 Contact persons

12 Business organizational information

13 Financial and banking information

14 Relationships with other entities

15 Project schedule

16 Project billing specifications

17 Individual personnel levels of system access and authority

18 Passwords

19 Security levels

20 Trust accounts

21 Escrow services

Entity Identification Register which stores the information received via the Billing Entity Form and Authorizing Entity Identification Form such as:

1 Entity Name

2 Entity Identification Number

3 Mailing addresses

4 Street addresses

5 Business phone numbers

6 Email addresses

7 Contact persons

8 Individual personnel levels of system access and authority

9 Passwords

10 Security levels

11 Business organizational information

12 Financial and banking information

13 Project Identification Number

14 Entity type/classification

15 Relationships with paying entities

16 Relationships with other billing entities

Reports: The BPA creates and uses several reports. For purposes of this specification, a report is data compiled and processed by the BPA and sent to a paying entity, although reports may also be prepared and provided to other entities. Reports may receive data from an entity as needed. The following reports are representative of the types of forms and reports used. A person familiar with the art would understand that the invention could process other report styles. These illustrative reports are:

Progress/Final Claims Release Report is a report created by the BPA, as required for the project, and sent to each paying entity (and any other required entity) showing the mechanic's liens and other claims adhering to the project and the conditional, unconditional and/or final claims releases created during the progress/final period.

Progress Billing Report/Final Billing Report is a report, sent to each paying entity, containing information sufficient for payments to be made directly to each billing entity. The Progress Billing Report/Final Billing Report provides a unique set of payment remittance instructions directly to a paying entity thus by-passing the sequential action of intermediary entities occupying a hierarchical business organization. The BPA creates the Progress Billing Report by compiling information from the Task Identification and Cost Register(s), the Progress Billing Form(s), and the Progress Authorization Form(s). This report shows the amounts billed for each task during the progress period and the amounts owed to each billing entity for work accomplished during this period. The Progress Billing Report contains adjustments, calculated by the BPA, as required by agreement between the Paying Entities and Billing Entities, such as the subtraction of a retention percentage from bills periodically presented prior to completion of the entire project. The Progress Billing Report also contains information regarding approvals by the authorizing entities and any adjustments mandated by these authorizing entities. The Progress Billing Report contains payment remittance instructions including the complete information required for a paying entity to pay each billing entity directly. The Final Billing Report is similar to a Progress Billing Report but is sent to each paying entity for payment of all final amounts, such as retention, owed to each billing entity at the end of a project when all bills from all entities have been submitted and the project is complete.

Payment: Each paying entity makes payment by any method it desires, using payment remittance instructions uniquely provided by the BPA system. A paying entity may request that the BPA act as its agent, performing the function of payment facilitator or escrow administrator between a financial institution and each billing entity using well understood methods such as standard automated clearing house transactions.

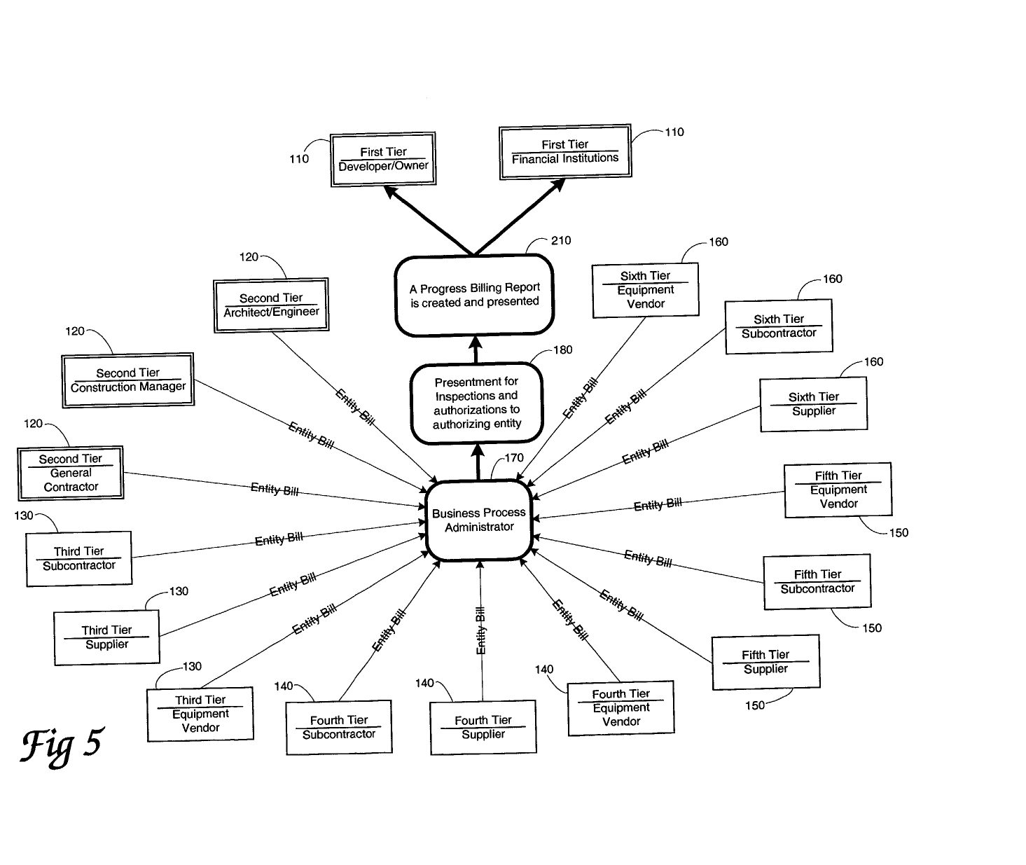

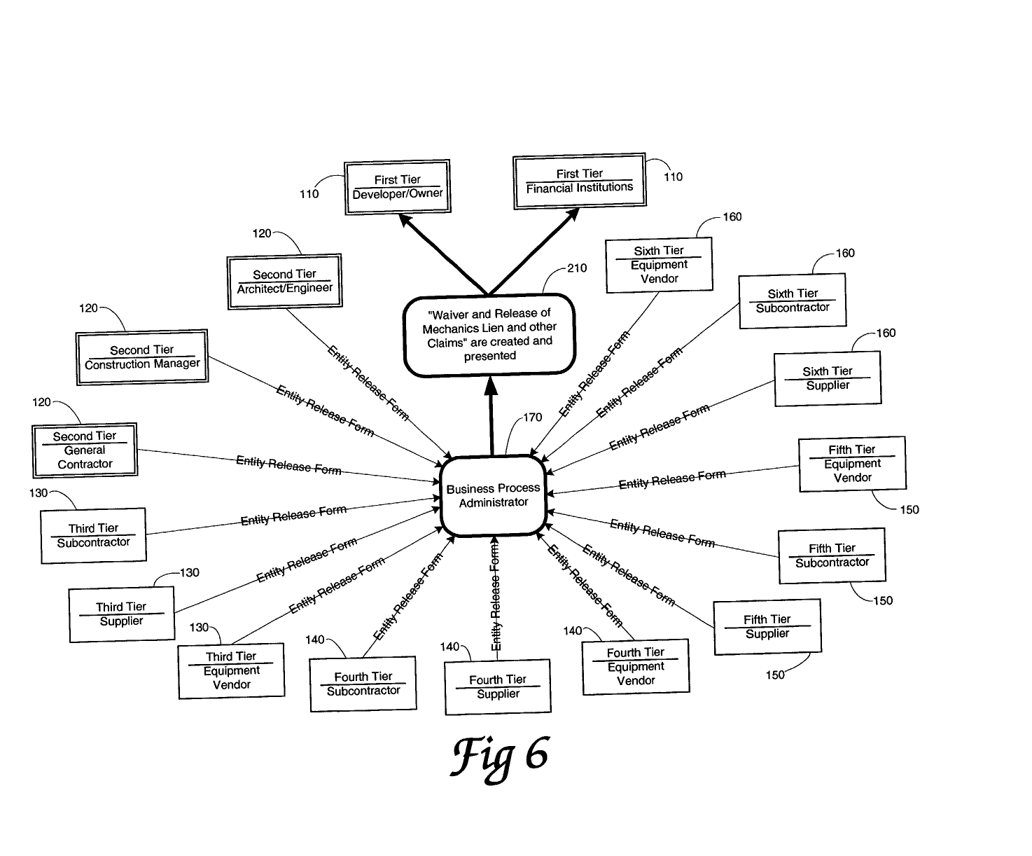

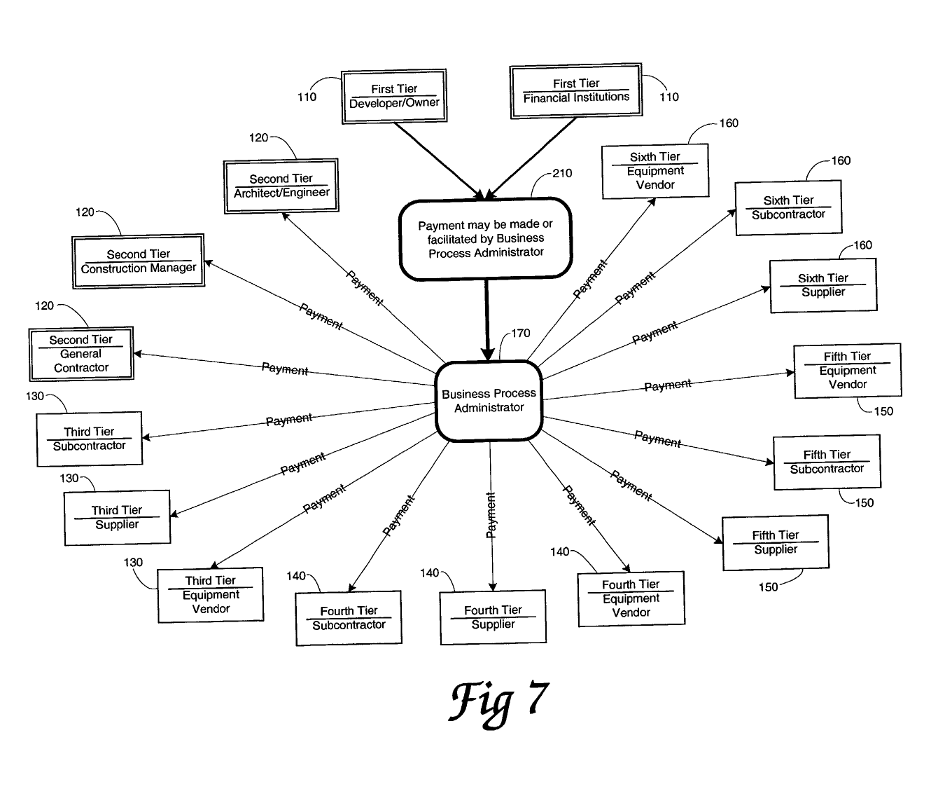

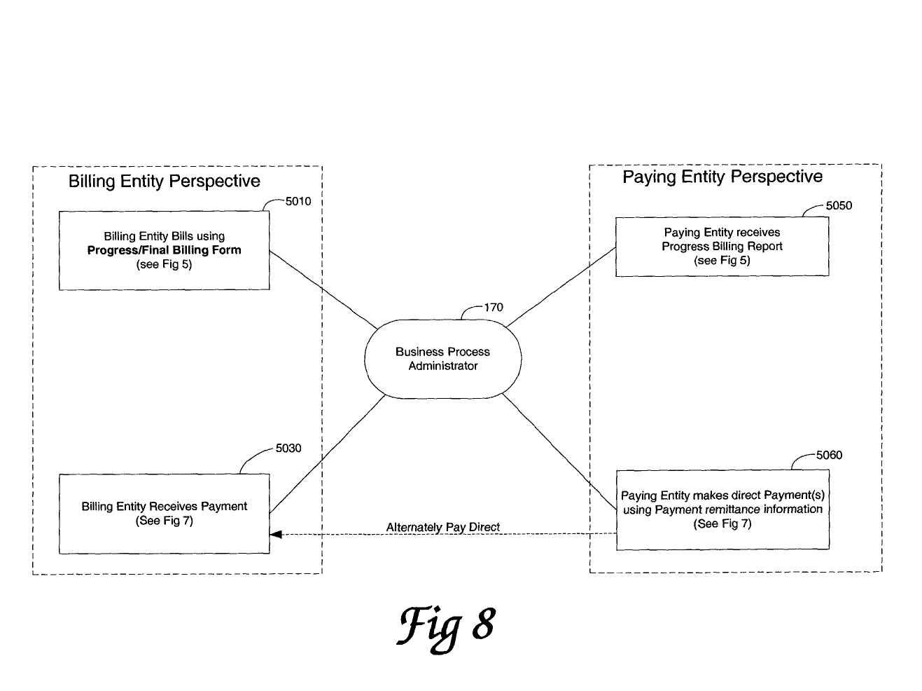

One embodiment of the invention shown in FIG. 8 is based upon the aspects of the billing/payment processes shown in FIGS. 5 and 7. FIG. 8 illustrates the process from the billing and paying entities' perspectives. Step 5010: Each billing entity transmits a Progress Billing form to the BPA. Step 5050: The BPA arranges for approvals, and creates and presents a compiled and approved Progress Billing Report directly to each paying entity thereby bypassing the prior art billing hierarchy. Step 5060: The Paying Entity then causes payments to be made directly to each billing entity listed on the Report which payments are received by the billing entity (step 5030), thereby bypassing the hierarchy in the payment aspect. Alternatively, payment may be made directly as shown. An alternate embodiment of the invention is shown in FIG. 9. FIG. 9 illustrates the process from the billing and paying entities' perspective (the process from the BPA's and authorizing entities' perspective is shown in FIG I1). This implements the aspects of FIGS. 5 and 7 along with the additional aspect in FIG. 6. The additional steps include 5020: Each billing entity transmitting various Claims Release forms to the BPA, and 5050: The BPA transmitting Claims Release Reports directly to each paying entity, thereby bypassing the hierarchy in claims release aspect as well as the billing and payment aspects.

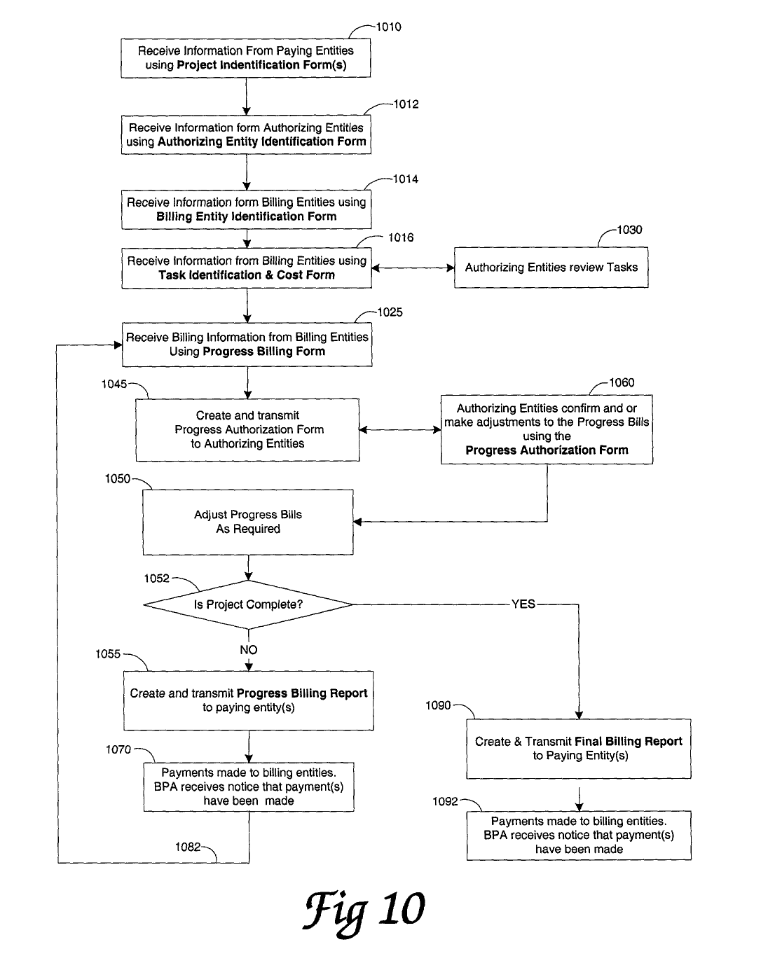

FIG. 10 shows in detail the embodiment of FIG. 8, which includes billing and payment methods without associated claims releases.

Identifying and defining a project as well as the entities populating the hierarchy is required to commence the invention. The following steps may occur in a sequentially different order than that shown.

1a. Each paying entity accesses the BPA and inputs information using the Project Identification Form (Step 1010)

1b. Paying Entity(ies) cause billing entities (Tiers 2 through N) and authorizing entities to be selected as part of the Hierarchical Business Structure that will complete the project. Each authorizing entity accesses the BPA and inputs information using the Authorizing Entity Identification Form 1012. Each billing entity accesses the BPA and inputs information using the Billing Entity Identification Form 1014 and the Task Identification and Cost Form 1016.

1c. The BPA selects each authorizing entity to review 1030 the completed Task Identification and Cost Form(s) and notify billing entities of changes to the definitions of “tasks” as may be required to comport with the definition of“tasks” in this specification

1d. The BPA collects the information provided via these forms. The information will be manipulated, organized and stored in system memory as registers.

2. Each Billing Entity completes “tasks(s),” partially or completely, resulting in billing event(s) in accordance with the project billing agreement(s) with the Paying Entity(ies). Each billing entity independently submits billing statements using the Progress Billing Form directly to the BPA 1025.

3. As required for a particular project, the BPA periodically combines the received billing data into a Progress Authorization Form for the work completed that period. Certain Bill Authorizing Entity(ies) are selected by BPA to approve the billed portions of the Tasks. The Progress Authorization Form is transmitted to these entities 1045. The selected authorizing Entity(ies) perform necessary inspections, make adjustments to the charges requested by the billing entities as presented in the Progress Authorization Form and transmit the adjustments and approvals to the BPA 1060. The BPA adjusts corrected Progress Billing Forms as required 1050.

4. If, at 1052, the Progress Authorization Form shows that the project is complete and all of the billing entities have billed 100 percent of their costs, the BPA advances to step 9 below (1090). If the project is not complete, the BPA proceeds to step 5 below (1055).

5. The BPA creates a Progress Billing Report 1055 based upon the Progress Billing Form(s) and the Progress Authorization Form(s).

6. The Progress Billing Report is submitted to each Paying Entity (1055).

7. Direct payment(s) (less retention) are made to each Billing Entity from the Paying entity (1070), using the provided payment remittance instructions, with or without the assistance of the BPA. These payments may be made using trust accounts and escrow services. The BPA receives notice of payments made.

8. At 1082 the BPA returns to step 2 above to receive billing information from billing entities.

9. The BPA creates a Final Billing Report 1090 based upon the Progress Billing Form(s) and the Progress Authorization Form(s). A Final Billing Report is submitted to Paying Entity(ies) 1090.

10. Direct payment(s) (including retention) are made from the Paying Entity(ies) to each Billing Entity using the payment remittance instructions provided by the BPA. These payments may be made using trust accounts and escrow services with or without the assistance of the BPA. The BPA receives notice of payments made. 1092 (See also FIG. 8 at 5030.)

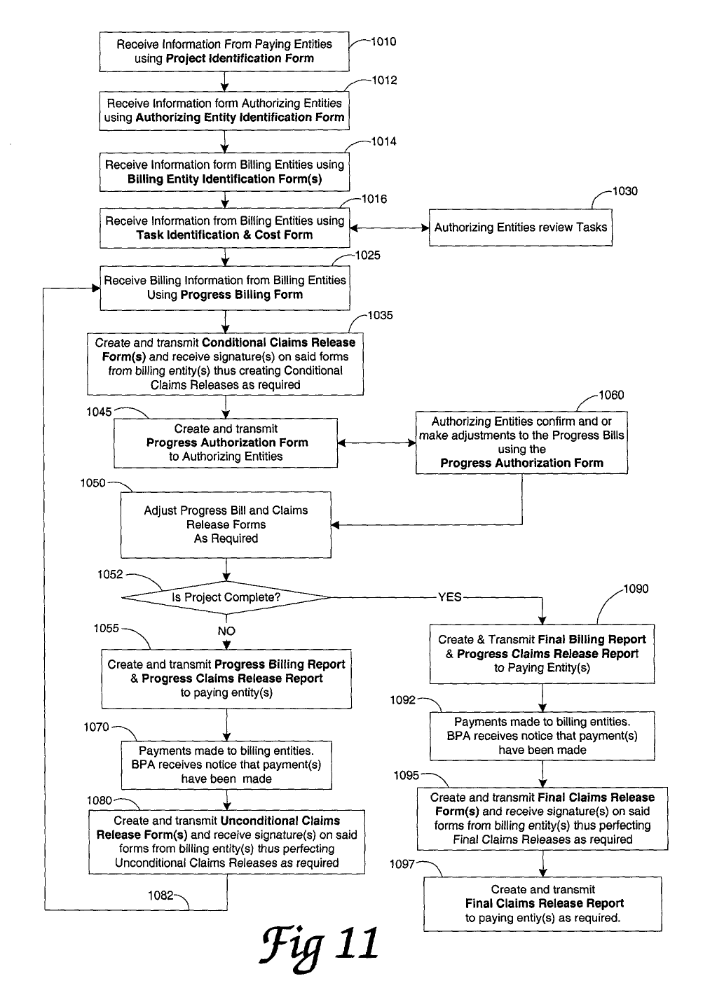

FIG. 11 shows in detail the alternate embodiment of FIG. 9, which includes billing and payment methods with associated claims releases.

Identifying and defining a project as well as the entities populating the hierarchy is required to commence the invention The following items may occur in a sequentially different order than that shown.

1a. Each paying entity accesses the BPA and inputs information using the Project Identification Form 1010.

1b. Paying Entity(ies) cause Billing Entities (Tiers 2 through N) and authorizing entities to be selected as part of the hierarchical business structure that will complete the project. Each authorizing entity accesses the BPA and inputs information using the Authorizing Entity Identification Form 1012. Each billing entity accesses the BPA and inputs information using the Billing Entity Identification Form 1014) and the Task Identification and Cost 1016.

1c. The BPA selects each authorizing entity to review the completed Task Identification and Cost Form(s) and notify billing entities of changes to the definitions of “tasks” as may be required to comport with the definition of “tasks” in this specification 1030.

1d. The BPA collects the information provided via these forms. The information will be manipulated, organized and stored in system memory as registers.

2. Each Billing Entity completes “tasks(s),” partially or completely, resulting in a billing event in accordance with the project billing agreement with the Paying Entity(ies). Each billing entity independently submits billing statements using the Progress Billing Form directly to the BPA 1025.

3. The BPA creates Conditional Claims Release Forms for the amounts billed 1035 and transmits the releases to each billing entity, which signs and returns (see also FIG. 9, at 5020) the releases to the BPA.

4. As required for a particular project, the BPA periodically combines the received billing data and claims release information into a Progress Authorization Form for the work completed that period 1045. Certain bill authorizing Entity(ies) are selected by BPA to approve the billed portions of the Tasks. The Progress Authorization Form is transmitted to these selected authorizing entities, which perform necessary inspections 1060, make adjustments to the charges requested by the billing entities as presented in the Progress Authorization Form, and transmit the adjustments and approvals to the BPA. The BPA adjusts corrected Progress Billing Forms and the associated Claims Release Forms as required 1050.

5. At 1052, if the Progress Authorization Form shows that the project is complete and all of the billing entities have billed 100 percent of their costs, the BPA advances to step 12 below, 1090. If the project is not complete the BPA proceeds to step 6, below, 1055.

6. The BPA 1055 creates a Progress Billing Report based upon the Progress Billing Forms and the Progress Authorization Form(s).

7. The BPA 1055 creates a Progress Claims Release Report based upon the Conditional Claims Release Forms and prior period Unconditional Claims Release Forms if any.

8. The Progress Billing Report and the Progress Claims Release Report are submitted to each Paying Entity 1055.

9. Direct payment(s) (less retention) are made to each Billing Entity from the Paying Entity(ies) 1070 using the provided payment remittance instructions, with or without the assistance of the BPA. These payments may be made using trust accounts and escrow services. The BPA receives notice of payments made.

10. The BPA creates Unconditional Claims Release Forms for the amounts paid 1080 and transmits the releases to the paid billing entities, which sign and return the releases to the BPA.

11. At 1082, the BPA returns to step 2, above (1025), to receive a billing information from billing entities.

12. The BPA 1090 creates a Progress Billing Report based upon the Progress Billing Forms and the Progress Authorization Form(s). The BPA 1055 creates a Progress Claims Release Report based upon the Conditional Claims Release Forms and prior period Unconditional Claims Release Forms, if any. A Final Billing Report and the Progress Claims Release Report are created and submitted to Paying Entity(ies) 1090.

13. Direct payment(s) (including retention) are made to each Billing Entity from the Paying Entity(ies) 1092 (see also FIG. 9, 5060) using payment remittance instructions provided by the BPA. These payments may be made using trust accounts and escrow services with or without the assistance of the BPA. The BPA receives notice of payments made.

14. The BPA creates Final Claims Release Forms for the total amounts paid 1095 and transmits the releases to the paid billing entities, which sign and return the releases to the BPA.

15. The BPA creates and transmits a Final Claims Release Report 1097 to the owner/developer and the financial institution(s).

As shown in FIG. 13, the BPA also compares tasks for a project to ensure against redundant task assignments and billing. Upon being queried to search for duplicated tasks 312, the BPA examines each task for each billing entity in the Task Cost and Identification Register 314. The BPA asks if the task is the same as any other task 316. If not, the BPA prepares and sends a report to the querying entity 318. If the task is duplicated, a report is prepared listing the matches and forwarded to the paying entity 320.

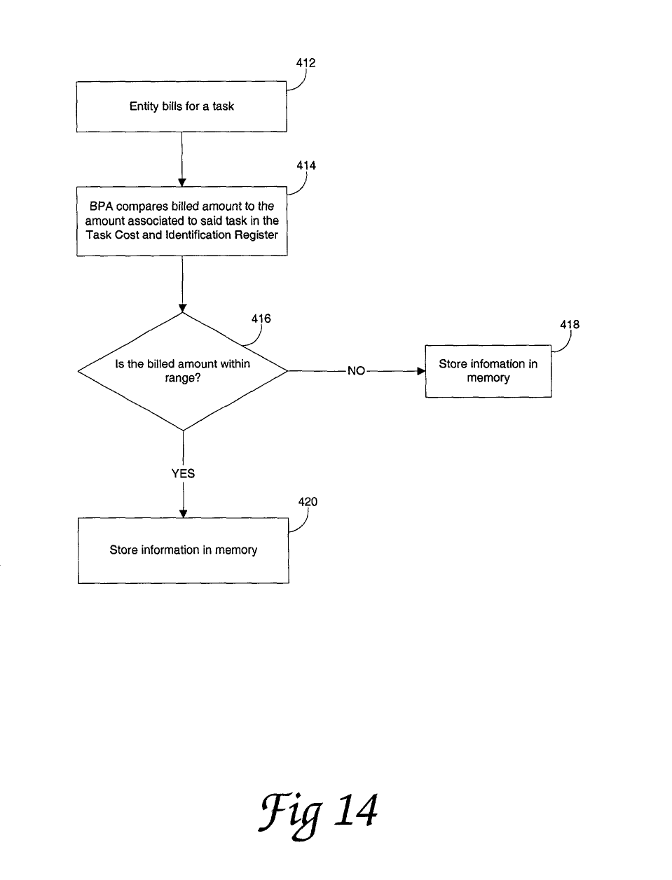

Referring to FIG. 14, the BPA is programmed to compare amounts billed by a billing entity for a task against stored costs to verify that the correct amount is being billed for the identified task. Once the BPA receives a bill for a task 412, it compares the billed amount to the amount associated with the billed task in the Task Cost and Identification Register 414. The BPA asks if the billed amount is within a stated range 416, and the resulting information is stored in memory 418, 420.

The present invention can be used to speed payment to all providers of materials and services on a construction project. This will save large sums of money that under the traditional system are wasted on finance charges and risk costs. The savings will accrue to project owners. The present invention provides the following additional advantages:

Provides better policing of the project with regard to mechanic's lien and other claims. The speedy and accurate releasing of mechanic's lien and other claims is highly valuable to property owners such as homeowner-consumers who do not understand this legal process or the administrative requirements. The added accuracy of identifying and releasing every claim associated with every task provides greater security and control to the property owner.

Provides a comprehensive Claims Release Report to the project owner/developer, lender, title company, and other interested parties. This report will save these entities valuable time in managing the inherent risk of construction project funding and final funding.

Provides the ability to audit low tier level entities on a task-by-task basis. At the beginning of a project this will ensure that all tasks are covered, e.g. that the total scope-of-work contemplated by design has been included. This also ensures that any redundant work assignments are eliminated.

Provides a property owner a greater degree of control of a construction project on a task-by task basis. Increasing control reduces risk. The system monitors work on the project to ensure that it progresses satisfactorily, and gives particular attention to controlling disbursement of funds.

Provides a better mechanism to eliminate over-billing and over-payment on a project. When a vendor entity is over-paid the owner/developer is harmed by added finance charges and increased risk.

Provides a faster and more efficient method of arranging for inspections and approvals of the work. This reduces risk to the owner.

Provides an efficient and functional mechanism to use escrow services and trust accounts for progress payments. This reduces risk for all parties involved with a construction project.

Provides a Task Cost and Identification Register that can be used by other software systems to manage other aspects of construction management and risk such as schedule control and collaborative problem solving.

Although the present invention has been described in terms of various embodiments, it is not intended that the invention be limited to these embodiments. Modification within the spirit of the invention will be apparent to those skilled in the art. For example, information regarding some entities and tasks may be entered into the system after periods of construction and progress billing have occurred as these entities are later contracted to do portions of work. Also payment to each entity can be managed to facilitate risk control. For example an entity that has not signed an Unconditional Claims Release for the preceding billing period may not be paid when the other billing entities are paid for the current period.

I claim:

1. A system for direct presentment and payment of bills generated by entities in a hierarchical business organization, the system using a computer that communicates over a network, the system comprising:
a hierarchical business organization having a plurality of tiers of entities, said entities related by a common business interest, said hierarchical business organization further including at least two tiers each having at least one billing entity, each said billing entity in contractual relation with a hiring entity in a superior tier of said business organization, said hierarchical business organization further including a first tier having at least one paying entity,
one or more memories for storing entity information on each of said entities of said hierarchical business organization,
one or more network interfaces for sending and receiving data to and from billing entity nodes and paying entity nodes, and
one or more processors in communication with said one or more memories,
wherein, when said one or more network interfaces receives billing data for a billing entity from one of said billing entity nodes, said one or more processors prepares a bill for said billing entity based on said billing data, said bill for transmission to a paying entity node.

2. The system for direct presentment and payment of bills of claim 1, further comprising:
said one or more memories for storing project information to identify said common business interest.

3. The system for direct presentment and payment of bills of claim 1, further comprising:
said entity information including identifying information on said at least one paying entity.

4. The system for direct presentment and payment of bills of claim 1, further comprising:
said bill further based on said stored entity information related to said billing entity.

5. The system for direct presentment and payment of bills of claim 1, further comprising.
said one or more processors generating payment remittance instructions related to said bill for transmission to a paying entity node.

6. The system for direct presentment and payment of bills of claim 1, further comprising:
said billing information including a list of payments made to each billing entity,
wherein, when said one or more network interfaces receives said billing data, said one or more processors verifies said billing data against said billing information.

7. The system for direct presentment and payment of bills of claim 1, further comprising:
said billing information including a list of tasks performed by each billing entity,
wherein, when said one or more network interfaces receives said billing data, said one or more processors verifies said billing data against said billing information.

8. The system for direct presentment and payment of bills of claim 1, further comprising:
said bill identifying a retention amount to be withheld from payment pursuant to said payment remittance instructions.

9. The system of claim 1, wherein:
said entity information includes a list of tasks, each said task associated with one of said billing entities, each said task further provided to said common business interest by only said one billing entity

10. The system of claim 9, wherein:
said bill for said billing entity includes only those tasks associated with said billing entity.

11. The system of claim 1, further comprising:
said entity information having a list of tasks, each said task associated with one of said billing entities, said task provided to said common business interest by only said one billing entity, and said entity information further having a list of stored costs, each said stored cost associated with one of said tasks.

12. The system for direct presentment and payment of bills of claim 9, wherein:
said one or more processors compares said list of tasks for each of said billing entities of said hierarchical business organization and identifies any task duplicated by more than one of said billing entities.

13. The system for direct presentment and payment of bills of claim 9, wherein:
each said billing data identifies at least one of said tasks of said list of tasks as a performed task for billing, and said one or more processors compares a billed cost submitted by said billing entity for said performed task against said cost associated with said task in said billing information to verify a match.

14. The system for direct presentment and payment of bills of claim 11, wherein:
said one or more processors compares said list of tasks for each of said billing entities of said hierarchical business organization and identifies redundant performance of any task of said list of tasks by more than one of said billing entities.

15. The system for direct presentment and payment of bills of claim 11, wherein:
said billing data identifies at least one of said tasks of said list of tasks as a performed task for billing, and said one or more processors compares a billed cost submitted by said billing entity associated with said performed task against said stored cost associated with said task in said billing information to verify a match.

16. The system of claim 1, wherein:
said payment remittance instructions are transmitted to said paying entity node.

17. The system of claim 1, further comprising:
a printer in communication with said one or more processors,
when said one or more processors generates said payment remittance instructions, said one or more processors instructs said printer to print a check for payment of said bill.

18. The system of claim 1, wherein:
when said payment remittance instructions are generated, said one or more processors submit instructions to a bank entity node to pay said billing entity.

19. The system of claim 1, wherein:
said one or more memories comprises a data set for storing, information for identification of said common business interest.

20. The system of claim 1, wherein:
said one or more memories comprises a data set for storing identifying information on billing entities.

21. The system of claim 1, wherein:
said one or more memories comprises a data set for storing identifying information on paying entities.

22. The system of claim 1, wherein:
said one or more memories comprises a data set for storing identifying information on authorizing entities.

23. The system of claim 1, wherein:
said first tier payment entity is a construction project owner.

24. The system of claim 1, wherein:
said first tier paying entity is a building contractor.

25. The system of claim 1, wherein:
said first tier paying entity is a financial institution.

26. The system of claim 1, further comprising:
one or more authorizing entity nodes, and
said one or more network interfaces are further for sending and receiving data to and from said authorizing entity nodes,
wherein, when said one or more network interfaces receives said billing data, said one or more processors generates and submits to at least one of said authorizing entity nodes an authorization request for payment of said bill, and
wherein, when said one or more network interfaces receives an approval or correction report from said authorizing entity node responsive to said authorization request, said one or more processors prepares said bid.

27. The system of claim 26, wherein:
when said approval or correction report comprises a correction request, said one or more processors submits that correction request to said billing entity node for correction of said bill.

28. The system of claim 26, wherein:
when said approval or correction report comprises an approval, said one or more processors generates said payment remittance instructions.

29. The system of claim 26, wherein:
said authorization request comprises a list of at least one tasks, each said task associated with one of said billing entities, and said task provided to said common business interest by said billing entity.

30. The system of claim 29, wherein:
said approval or correction report includes a report for verifying completion of each said item of value of each said task.

31. The system of claim 1, further comprising:
said one or more memories including a data set for storing claim information on each of said billing entities, and
wherein, when said one or more network interfaces receives a claim release from one of said billing entity nodes for one of said billing entities, said one or more processors generates a claims release report for transmission to said paying entity node, said claims release report including claim information related to said billing entity.

32. The system of claim 31, wherein:
said claim release comprises an unconditional claims release.

33. The system of claim 31, wherein:
said claim release comprises a final claim release.

34. The system of claim 1, further comprising:
said one or more memories further for maintaining claim information on each of said billing entities,
one or more authorizing entity nodes, and
said one or more network interfaces further for sending and receiving data to and from said one or more authorizing entity nodes,
wherein, when said one or more network interfaces receives said billing data, said one or more processors generates and submits to at least one of said authorizing entity nodes an authorization request for payment of said bill, and
wherein, when said one or more network interfaces receives an approval from said authorizing entity node responsive to said authorization request, said one or more processors submits a request for a claim release to said billing entity node consistent with said approval, said a claim release further consistent with said claim information related to said billing entity.

35. The system of claim 34, wherein:
when said one or more network interfaces receives a correction request from said authorizing entity node responsive to said authorization request, said one or more processors submits said correction request to said billing entity node for correction of said bill.

36. The system for direct presentment and payment of bills of claim 1, wherein:
when said one or more processor receives a request for a billing report from one of said paying entity nodes, said one or more processors creates that report for submission to said paying entity node.

37. The system for direct presentment and payment of bills of claim 36, wherein:
said billing report comprises a billing status for each said billing entity of said hierarchical business organization.

38. The system for direct presentment and payment of bills of claim 36, wherein:
said billing report comprises a total billing status for all said billing entities of said hierarchical business organization.

39. The system for direct presentment and payment of bills of claim 1, further comprising:
a user interface associated with a billing entity, said user interface in communication with one of said billing entity nodes, wherein
said one or more processors prepares a billing template for input of said billing data by said billing entity.

40. The system for direct presentment and payment of bills of claim 39, wherein:
said billing template comprises a billing status for said billing entity.

41. The system for direct presentment and payment of bills of claim 1, further comprising.
said billing data including a billed total amount,
said bill having a discounted bill total amount for presentation to said paying entity, said one or more processors calculating said discounted bill total amount by subtracting from said billed total amount a discount amount.

42. The system for direct presentment and payment of bills of claim 1, wherein:
when said one or more processor receives a request for a billing report from one of said paying entity nodes, said one or more processors creates that report for submission to said paying entity node.

43. The system for direct presentment and payment of bills of claim 42, wherein:
said billing report comprises a billing status for each said billing entity of said hierarchical business organization.

44. The system for direct presentment and payment of bills of claim 42, wherein:
said billing report comprises a total billing status for all said billing entities of said hierarchical business organization.

45. The system for direct presentment and payment of bills of claim 1, further comprising
a user interface for a billing entity, said user interface in communication with one of said billing entity nodes, and
said one or more processors prepares a billing template for input of said billing data by said billing entity.

46. The system for direct presentment and payment of bills of claim 45, wherein:
said billing template comprises a billing status for said billing entity.

47. The system for direct presentment and payment of bills of claim 1, wherein:
said one or more processors calculates a discount amount for said bill, and said bill identifies said discount amount for reduction of a bill total amount.

48. A method for direct presentment and payment of bills generated in a hierarchical business organization, using a computer that communicates over a network, the method comprising:
storing entity information on each of a plurality of entities of a hierarchical business organization having a plurality of tiers of entities, said entities related by a common business interest, said entities comprising a plurality of billing entities, each said billing entity in contractual relation with a hiring entity in a superior tier of said business organization, said hierarchical business organization having at least two tiers each having at least one billing entity, said hierarchical business organization further having at least one tier having at least one paying entity,
receiving billing data from at least one of said billing entities, and
preparing a bill for said billing entity based on said billing data, said bill further based on said stored entity information related to said billing entity.

49. The method for direct presentment and payment of bills of claim 48, further comprising:
generating payment remittance instructions for transmission to a paying entity, said payment remittance instructions for payment of said bill to said billing entity.

50. The method for direct presentment and payment of bills of claim 48, further comprising:
verifying said billing data against a list of payments made to each billing entity stored in said billing information, and
verifying said billing data against a list of tasks performed by each billing entity stored in said billing information.

51. The method for direct presentment and payment of bills of claim 48, further comprising:
identifying a retention amount on said bill, said retention amount to be withheld from payment pursuant to said payment remittance instructions.

52. The method of claim 48, further comprising:
storing in said entity information a list of tasks, each said task associated with one of said billing entities, and
including an item of value in said task provided to said common business interest by only said one billing entity.

53. The method of claim 52, further comprising:
including in said bill only said items of value for those tasks associated with said billing entity

54. The method of claim 48, further comprising:
associating each task in a list of tasks with one of said billing entities,
including in said task an item of value provided to said common business interest by only said billing entity, and
associating each said stored cost in a list of stored costs with one of said tasks.

55. The method of claim 54, further comprising:
identifying any task of said list of tasks for all said billing entities of said hierarchical business organizations for duplicate performance by more than one of said billing entities.

56. The method for direct presentment and payment of bills of claim 54, further comprising
identifying in said billing data at least one of said tasks of said list of tasks as being completed,
comparing a submitted cost presented by said billing entity associated with said task against said stored cost associated with said task in said billing information to verify a match.

57. The method for direct presentment and payment of bills of claim 1, further comprising:
submitting said payment instructions to said paying entity.

58. The method for direct presentment and payment of bills of claim 1, further comprising:
instructing a printer to print a check for payment of said bill in compliance with said payment remittance instructions

59. The method for direct presentment and payment of bills of claim 1, further comprising:
communicating instructions over a network to a bank to pay said billing entity according to said payment remittance instructions.

60. The method for direct presentment and payment of bills of claim 48, further comprising:
identifying a project in a data set stored in said one or more memories.

61. The method for direct presentment and payment of bills of claim 48, further comprising:
identifying billing entities and paying entities in a data set stored in said one or more memories.

62. The method for direct presentment and payment of bills of claim 48, further comprising:
identifying one or more authorizing entities in a data set stored in said one or more memories.

63. The method for direct presentment and payment of bills of claim 48, further comprising:
generating and submitting to at least one of one or more authorizing entities an authorization request for payment of said bill,
receiving an approval or correction report from said authorizing entity responsive to said authorization request, and
generating said payment remittance instructions.

64. The method for direct presentment and payment of bills of claim 63, further comprising:
receiving a correction request from said authorizing entity responsive to said authorization request, and
submitting that correction request to said billing entity for correction of said bill.

65. The method for direct presentment and payment of bills of claim 63, further comprising:
receiving an approval from said authorizing entity responsive to said authorization request, and
generating said payment remittance instructions.

66. The method for direct presentment and payment of bills of claim 63, further comprising.
associating each task of a list of at least one tasks with one of said billing entities, said task provided to said common business interest by said billing entity, and
including said list of at least one task in said authorization request.

67. The method for direct presentment and payment of bills of claim 66, further comprising
assigning inspection authority to at least one authorizing entity,
conducting an inspection for completion of said list of tasks, and
preparing an approval or correction report.

68. The method for direct presentment and payment of bills of claim 67, further comprising:
verifying completion of each said task.

69. The method for direct presentment and payment of bills of claim 68, further comprising:
preparing an approval or correction report, including completion verification information on said tasks.

70. The method for direct presentment and payment of bills of claim 48, further comprising:
storing claim information on each of said entities in a data set in said one or more memories,
receiving a claim release from one of said billing entities,
generating a claims release report for transmitting to said paying entity, and
including in said claims release report claim information related to said billing entity.

71. The method for direct presentment and payment of bills of claim 70, further comprising:
preparing an unconditional claims release.

72. The method for direct presentment and payment of bills of claim 70, further comprising:
preparing an final claims release.

73. The method for direct presentment and payment of bills of claim 48, further comprising:
storing claim information on each of said billing entities,
generating and submitting to at least one authorizing entity an authorization request for payment of said bill in response to receipt of said billing data from said billing entity,
receiving an approval from said authorizing entity responsive to said authorization request, and
submitting a request for a claim release to said billing entity consistent with said approval, said claim release further consistent with said claim information related to said billing entity.

74. The method for direct presentment and payment of bills of claim 73, further comprising:
receiving a correction request from said authorizing entity, and
submitting said correction request to said billing entity for correction of said bill.

75. The method for direct presentment and payment of bills of claim 48, further comprising.
receiving a request for a billing report from one of said paying entities,
creating that report, and
submitting that report to said paying entity.

76. The method for direct presentment and payment of bills of claim 74, further comprising:
including in said billing a reported billing status for each said billing entity of said hierarchical business organization.

77. The method for direct presentment and payment of bills of claim 75, further comprising:
including in said billing report a total billing status for all said billing entities of said hierarchical business organization.

78. The method for direct presentment and payment of bills of claim 48, further comprising:
preparing a billing template for input of billing data by a billing entity, and
transmitting said billing template to a user interface over a network, said user interface associated with said billing entity.

79. The method for direct presentment and payment of bills of claim 78, further comprising
including a billing status for said billing entity in said billing template.

80. The method for direct presentment and payment of bills of claim 48, further comprising:
calculating a discount amount, and
calculating a discounted bill total amount for presentation to said paying entity by subtracting from a billed total amount said discount amount, said billed total amount included in said billing data.

81. A system for direct presentment and payment of bills generated by entities in a hierarchical business organization, the system using a computer that communicates over a network, the system comprising:
a hierarchical business organization having a plurality of tiers of entities, said entities related by a common business interest, said hierarchical business organization further including at least two tiers each having at least one billing entity, each said billing entity in contractual relation with a hiring entity in a superior tier of said business organization, said hierarchical business organization including a first tier having at least one paying entity, and said hierarchical business organization further including at least one tier having at least one authorizing entity,
one or more memories for storing entity information on each of said entities of said hierarchical business organization,
one or more processors in communication with said one or more memories, and
one or more network interfaces for sending and receiving data to and from billing entity nodes, paying entity nodes, and authorizing entity nodes,
wherein, when said one or more network interfaces receives billing data for a billing entity from one of said billing entity nodes, said one or more processors generates and submits to at least one of said authorizing entity nodes an authorization request for authorization to pay said bill, and
wherein, when said one or more network interfaces receives an approval or correction report from said authorizing entity node responsive to said authorization request, said one or more processors prepares a bill for said billing entity based on said billing data, said bill for transmission to a paying entity node.

82. The system of claim 81, wherein:
when said approval or correction report comprises a correction request, said one or more processors submits that correction request to said billing entity node for correction of said bill.

83. The system of claim 81, wherein:
when said approval or correction report comprises an approval, said one or more processors generates said payment remittance instructions.

84. The system of claim 81, wherein:
said authorization request comprises a list of at least one tasks, each said task associated with one of said billing entities, and said task provided to said common business interest by said billing entity.

85. The system of claim 84, wherein:
said approval or correction report includes a report for verifying completion of each said item of value of each said task.

86. A system for direct presentment and payment of bills generated by entities in a hierarchical business organization, the system using a computer that communicates over a network, the system comprising:
a hierarchical business organization having a plurality of tiers of entities, said entities related by a common business interest, said hierarchical business organization further including at least two tiers each having at least one billing entity, each said billing entity in contractual relation with a hiring entity in a superior tier of said business organization, said hierarchical business organization further including a first tier having at least one paying entity,
said one or more memories including a data set for storing claim information on each of said billing entities,
one or more network interfaces for sending and receiving data to and from billing entity nodes and paying entity nodes, and
one or more processors in communication with said one or more memories,
wherein, when said one or more network interfaces receives a claim release from one of said billing entity nodes for one of said billing entities, said one or more processors generates a claims release report for transmission to said paying entity node, said claims release report including claim information related to said billing entity.

87. The system of claim 86, wherein
one or more memories further for storing entity information on each of said entities of said hierarchical business organization,
when said one or more network interfaces receives billing data for a billing entity from one of said billing entity nodes, said one or more processors generates a claim release for transmission to said billing entity node, and
when said one or more network interfaces receives said claim release from said billing entity, said one or more processors prepares a bill for said billing entity based on said billing data, said bill for transmission to a paying entity node, said bill including entity information related to said billing entity.

88. A computer program product comprising a machine readable medium on which is provided program instructions for performing a method for direct presentment and payment of bills generated in a hierarchical business organization using a computer that communicates over a network, the program instructions comprising:
program code for storing entity information on each of a plurality of entities of a hierarchical business organization having a plurality of tiers of entities, said entities related by a common business interest, said entities comprising a plurality of billing entities, each said billing entity in contractual relation with a hiring entity in a superior tier of said business organization, said hierarchical business organization having at least two tiers each having at least one billing entity, said hierarchical business organization further having at least one tier having at least one paying entity,
receiving billing data from at least one of said billing entities, and
program code for preparing a bill for said billing entity based on said billing data, said bill further based on said stored entity information related to said billing entity.

89. The computer program product of claim 88, further comprising:
program code for generating payment remittance instructions for transmission to a paying entity, said payment remittance instructions for payment of said bill to said billing entity.

90. The system of claim 42, wherein:
said billing report comprises a billing status on a plurality of said billing entities.

91. The system of claim 1, wherein:
said one or more processors calculates a fee amount for said bill, and said bill identifies said fee amount for inclusion in a billed total amount.
